(19) United States
(12) Patent Application Publication
(10) Pub. No.: US 2017/0014909 A1
(43) Pub. Date: Jan. 19, 2017

(54) METHOD FOR MANUFACTURING ADDITIVE MANUFACTURED OBJECT, AND MIXED MATERIAL

(71) Applicant: Kabushiki Kaisha Toshiba, Tokyo (JP)

(72) Inventors: Masayuki TANAKA, Yokohama (JP); Hiroshi OHNO, Yohohama (JP); Morihiro MACHIDA, Chuo (JP)

(73) Assignee: Kabushiki Kaisha Toshiba, Tokyo (JP)

(21) Appl. No.: 15/124,305

(22) PCT Filed: Sep. 10, 2014
(86) PCT No.: PCT/JP2014/073983

§ 371 Date: Sep. 7, 2016

(30) Foreign Application Priority Data
Mar. 31, 2014 (JP) 2014-073630

(51) Int. Cl. B22F 7/02; B22F 3/24; B22F 7/00; B23K 26/342; B29C 67/00; B23K 26/144; B33Y 10/00; B33Y 30/00; B33Y 50/02; B33Y 80/00; B22F 3/105; B23K 26/00

(52) U.S. Cl. CPC B22F 7/02; B22F 3/1055; B22F 3/24; B22F 7/008; B23K 26/342; B23K 26/0006; B23K 26/144; B33Y 10/00; B33Y 30/00; B33Y 50/02; B33Y 80/00; B29C 67/0077; B29C 67/0088; B22F 2003/1057; B22F 2003/248; B22F 2998/10; B23K 2203/172

(57) ABSTRACT

A method for manufacturing an additive manufactured object according embodiments includes supplying a powdered first material capable of being melted or sintered by irradiation with energy rays; supplying a powdered second material through which the energy rays are transmitted; melting or sintering the first material by irradiation with the energy rays; and solidifying the first material after melting or solidifying the first material by sintering.

### FIELD

Embodiments of the present invention relate to a method for manufacturing an additive manufactured object and a mixed material.

### BACKGROUND

Conventionally, a method for manufacturing an additive manufactured object has been known which manufactures a manufactured object of a three-dimensional shape, by supplying a powdered material in a layer shape, melting the supplied material using laser beam, and solidifying the material after melting.

### CITATION LIST

### Patent Literature

Patent Literature 1: Japanese Laid-open Patent Publication No. 2007-216595

### SUMMARY OF THE INVENTION

### Problem to be Solved by the Invention

In the conventional method for manufacturing the additive manufactured object, when the supplied material is irradiated with laser beam, if the laser beam is also incident on a portion, which is not desired to be solidified, of the supplied material, there is a problem of melting and solidification of the portion which is not desired to be solidified. Thus, for example, it is meaningful to obtain a new method for manufacturing an additive manufactured object and a mixed material capable of suppressing solidification of a portion, which is not desired to be solidified, of the supplied material

### Means for Solving Problem

A method for manufacturing an additive manufactured object according embodiments comprises supplying a powdered first material capable of being melted or sintered by irradiation with energy rays; supplying a powdered second material through which the energy rays are transmitted; melting or sintering the first material by irradiation with the energy rays; and solidifying the first material after melting or solidifying the first material by sintering.

### BRIEF DESCRIPTION OF DRAWINGS

FIG. 1 is a schematic diagram of an additive manufacturing apparatus of a first embodiment.

FIG. 2 is a schematic diagram illustrating a part of an additive manufacturing apparatus of the first embodiment.

FIG. 3 is a cross-sectional view illustrating a stage of the first embodiment, and a first material supply device located at a supply position.

FIG. 4 is a perspective view illustrating the stage of the first embodiment, and the first material supply device located at the supply position.

FIG. 5 is a cross-sectional view illustrating the stage of the first embodiment, and a first material supply device in which a shielding wall is located at a closed position.

FIG. 6 is a flowchart illustrating an example of a procedure for manufacturing the additive manufactured object of the first embodiment.

FIG. 7 is a cross-sectional view illustrating the stage of the first embodiment, and a second material supply device.

FIG. 8 is a cross-sectional view illustrating a stage in which the additive manufactured object of the first embodiment is manufactured.

FIG. 9 is a plan view illustrating a supply region of the first embodiment.

FIG. 10 is a schematic diagram of an additive manufacturing apparatus of the second embodiment.

FIG. 11 is a schematic diagram illustrating a part of a nozzle of the second embodiment.

FIG. 12 is a flowchart illustrating an example of a procedure for manufacturing the additive manufactured object of the second embodiment.

FIG. 13 is an explanatory view illustrating a part of a manufacturing process of the additive manufactured object of the second embodiment.

FIG. 14 is a schematic diagram illustrating the additive manufactured object and the support member of the second embodiment.

FIG. 15 is a schematic diagram illustrating the additive manufactured object in a state in which the support member of the second embodiment is removed.

FIG. 16 is a schematic diagram illustrating a part of the support member of the second embodiment.

### DETAILED DESCRIPTION

### First Embodiment

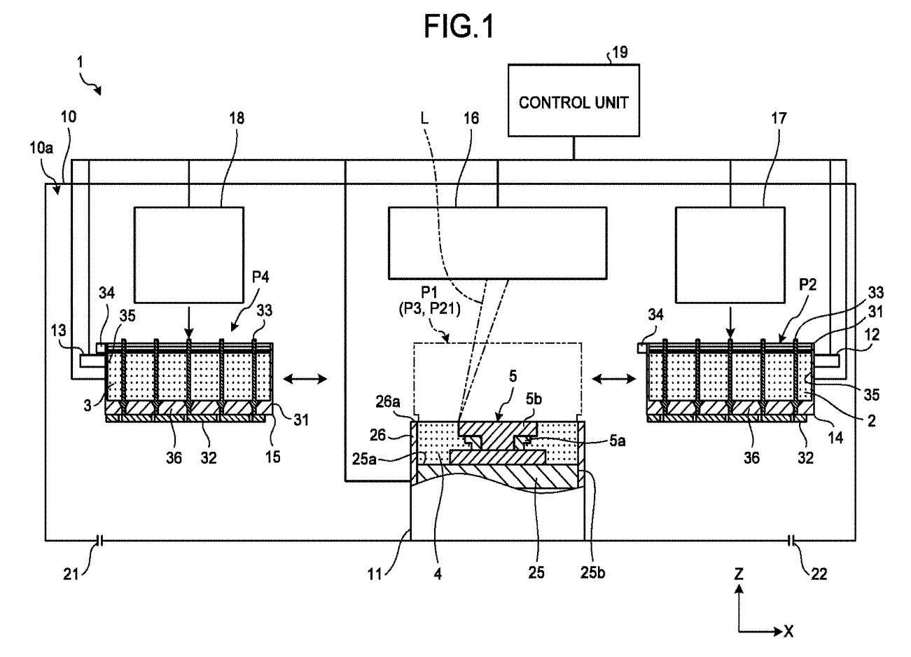

Hereinafter, a first embodiment will be described with reference to FIGS. 1 to 9. In the specification, a vertically upper part is defined as a superior direction, and a vertically lower part is defined as an inferior direction. Further, plurality of expressions may be written together in components according to the present embodiment and description of the components. The components and description thereof are not prevented from being expressed with other expressions that are not described. Furthermore, the components and description, in which a plurality of expressions is not described, are not prevented from being expressed in different ways.

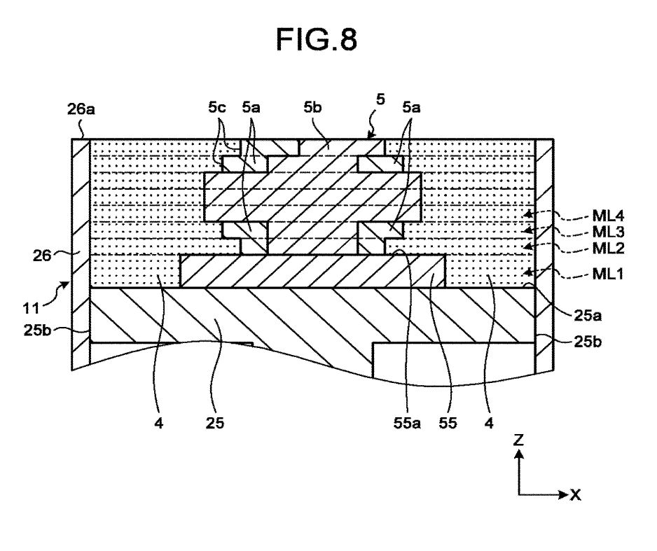

FIG. 1 is a schematic diagram of an additive manufacturing apparatus 1. The additive manufacturing apparatus 1 manufactures an additive manufactured object 5 of a three-dimensional shape, by repeating the formation of layers using materials 2 to 4, and a solidification of a portion (a layer 5c, see FIG. 8) of the materials 2 and 3 among the layers. FIG. 1 illustrates the additive manufactured object 5 in the process of formation.

In the present embodiment, each of the materials 2 to 4 is a powdered material having a central particle diameter of about 40 μm. In addition, the materials 2 to 4 are materials of different kinds from each other. The materials 2 and 3, for example, are a metal material resin material or the like. The material 4 is a material through which a laser beam L is transmitted. The material 4, for example, is a glass material or the like. The material 4 has absorptivity of the laser beam L lower than the materials 2 and 3. The materials 2 and 3 are also referred to as materials for manufactured object, and the material 4 is also referred to as a support material or an enclosure material. In the present embodiment, the material 2 and material 3 are an example of a first material, and the material 4 is an example of a second material.

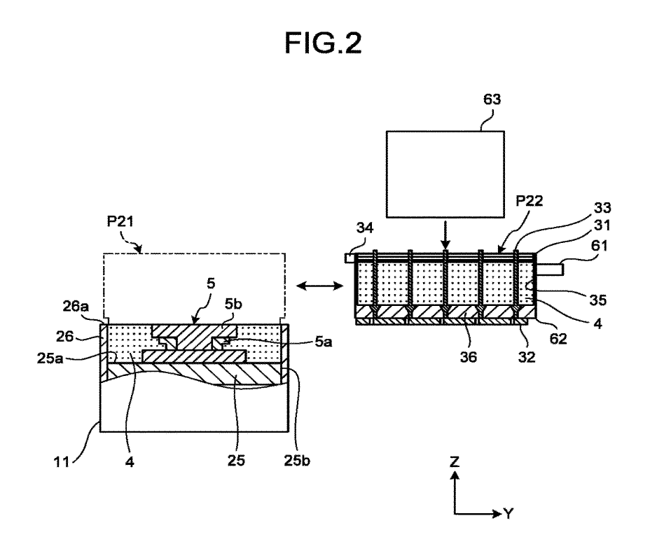

As illustrated in FIG. 1, the additive manufacturing apparatus 1 includes a processing tank 10, a stage 11, a first moving device 12, a second moving device 13, a third moving device 61 (see FIG. 2), a first material supply device 14, a second material supply device 15, a third material supply device 62 (see FIG. 2), an optical device 16, a first material replenishing device 17, a second material replenishing device 18, a third material replenishing device 63 (see FIG. 2), and a control unit 19.

The processing tank 10, for example, may also be referred to as a casing. The stage 11, for example, may also be referred to as a table, a manufacturing region or an application region. The first, second and third moving devices 12, 13 and 61 are an example of a moving unit, and for example, may also be referred to as a conveying unit or a retracting unit. The first, second and third material supply devices 14, 15 and 62 are an example of a supply unit, and for example, may also be referred to as a holding unit, a dropping unit or a spraying unit. The optical device 16 is an example of a manufacturing unit, and for example, may also be referred to as a forming unit, a solidifying unit or a coupling unit. The first, second, and third material replenishing devices 17, 18 and 63, for example, may also be referred to as a supply unit or a filling unit.

As illustrated in the drawings, an X-axis, a Y-axis and a Z-axis are defined in the present embodiment. The X-axis, the Y-axis and the Z-axis are orthogonal to one another. In the present embodiment, an X-axis direction is assumed as a width direction of the first material supply device 14, a Y-axis direction is assumed as a depth (length) direction of the first material supply device 14, and a Z-axis direction is assumed as a height direction of the first material supply device 14.

The processing tank 10, for example, is formed in a sealable box-shape. The processing tank 10 has a processing chamber 10a. The processing chamber 10a houses the stage 11, the first moving device 12, the second moving device 13, the third moving device 61, the first material supply device 14, the second material supply device 15, the third material supply device 62, the optical device 16, the first material replenishing device 17, the second material replenishing device 18, and the third material replenishing device 63. Further, the stage 11, the first moving device 12, the second moving device 13, the third moving device 61, the first material supply device 14, the second material supply device 15, the third material supply device 62, the optical device 16, the first material replenishing device 17, the second material replenishing device 18, and the third material replenishing device 63 may be disposed outside the processing chamber 10a.

The processing chamber 10a of the processing tank 10 is provided with a supply port 21 and a discharge port 22. For example, a supply device provided outside the processing tank 10 supplies inert gases, such as nitrogen and argon, into the processing chamber 10a from the supply port 21. For example, a discharge device provided outside the processing tank 10 discharges the inert gas of the processing chamber 10a from the discharge port 22.

The stage 11 has a mounting table 25 and a peripheral wall 26. The mounting table 25, for example, is a square plate material. The shape of the mounting table 25 is not limited thereto, and the mounting table 25 may be a member having other shapes such as another quadrangle (a quadrilateral shape) such as a rectangle, a polygon, a circle, and a geometrical shape. The mounting table 25 has an upper face 25a, and four end faces 25b. The upper face 25a is a quadrangular flat face of 250 mm×250 mm. The size of the upper face 25a is not limited thereto. The end faces 25b are faces each of which is orthogonal to the upper face 25a.

The peripheral wall 26 extends in the direction along the Z-axis, and is formed in a quadrangular tubular shape surrounding the mounting table 25. The four end faces 25b of the mounting table 25 are in contact with each of the inner faces of the peripheral wall 26. The peripheral wall 26 is formed in the shape of a quadrangular frame, and has an opened upper end 26a.

The mounting table 25 is movable inside the peripheral wall 26 in a direction along the Z-axis by various devices, such as a hydraulic elevator. When the mounting table 25 moves to the highest position, the upper face 25a of the mounting table 25 and the upper end 26a of the peripheral wall 26 form substantially the same plane.

The first moving device 12 has a telescopic arm coupled to the first material supply device 14, a drive unit which drives the telescopic arm, or other various devices, and moves the first material supply device 14, for example, in parallel. The first moving device 12 moves the first material supply device 14, for example, between a supply position P1 and a standby position P2.

FIG. 1 illustrates the first material supply device 14 located at the supply position P1 by a two-dot chain line, and illustrates the first material supply device 14 located at the standby position P2 by a solid line. The first material supply device 14 located at the supply position P1 is located above the stage 11. The first material supply device 14 located at the standby position P2 is located in a location deviated from the supply position P1. For example, the standby position P2 is spaced apart from the supply position P1, in a direction along at least one of the X-axis and the Y-axis. In this way, the first moving device 12 changes the relative position of the first material supply device 14 with respect to the stage 11. The first moving device 12, for example, may move the stage 11 with respect to the first material supply device 14.

The second moving device 13 has a telescopic arm coupled to the second material supply device 15, a drive unit or the like for driving the telescopic arm, or other various devices, and moves the second material supply device 15, for example, in parallel. The second moving device 13 moves the second material supply device 15, for example, between a supply position P3 and a standby position P4.

FIG. 1 illustrates the second material supply device 15 located at the supply position P3 by a two-dot chain line, and illustrates the second material supply device 15 located at the standby position P4 by a solid line. The supply position P3 of the second material supply device 15 is the same position as the supply position P1 of the first material supply device 14.

The second material supply device 15 located at the supply position P3 is located above the stage 11. The second material supply device 15 located at the standby position P4 is located in a location deviated from the supply position P3. For example, the standby position P4 is spaced apart from the supply position P3, in the direction along at least one of the X-axis and the Y-axis. In this way, the second moving device 13 changes the relative position of the second material supply device 15 with respect to the stage 11. The second moving device 13, for example, may move the stage 11 with respect to the second material supply device 15.

FIG. 2 illustrates a third material supply device 62 located at the supply position P21 by a two-dot chain line, and illustrates the third material supply device 62 located at the standby position P22 by a solid line. The third moving device 61 has a telescopic arm coupled to the third material supply device 62, a drive unit for driving the telescopic arm, or other various devices, and moves the third material supply device 62, for example, in parallel. The third moving device 61 moves the third material supply device 62, for example, between the supply position P21 and the standby position P22.

The supply position P21 of the third material supply device 62 is the same position as the supply position P1 of the first material supply device 14. The supply positions P1, P3 and P21 of the first, second and third material supply devices 14, 15 and 62 are not limited to the positions illustrated in FIGS. 1 and 2. Further, the standby positions P2, P4 and P22 of the first, second and third material supply devices 14, 15 and 62 are not limited to the positions illustrated in FIGS. 1 and 2.

The third material supply device 62 located at the supply position P21 is located above the stage 11. The second material supply device 62 located at the standby position P22 is located in a location deviated from the supply position P21. For example, the standby position P22 is spaced apart from the supply position P21, in a direction along at least one of the X-axis and the Y-axis. In this way, the third moving device 61 changes the relative position of the third material supply device 62 with respect to the stage 11. Further, the third moving device 61, for example, may move the stage 11 with respect to the third material supply device 62.

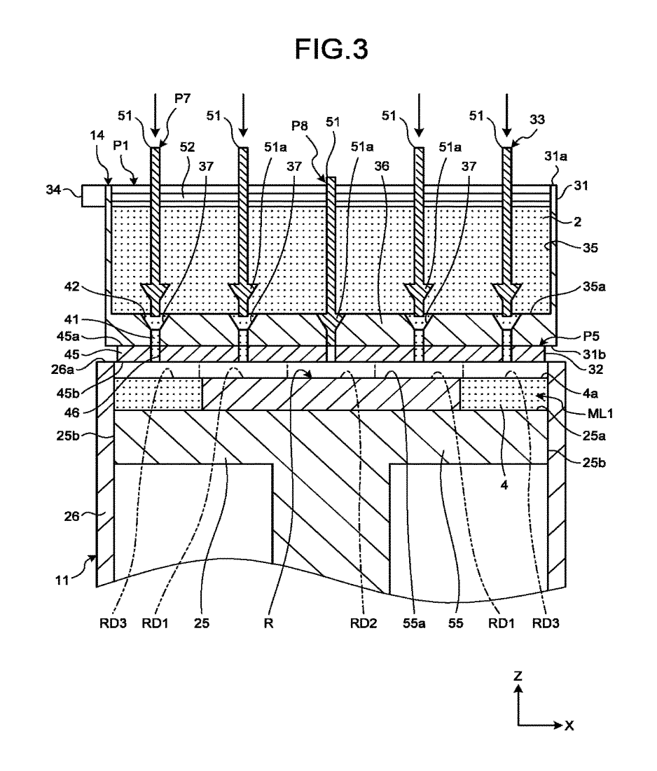

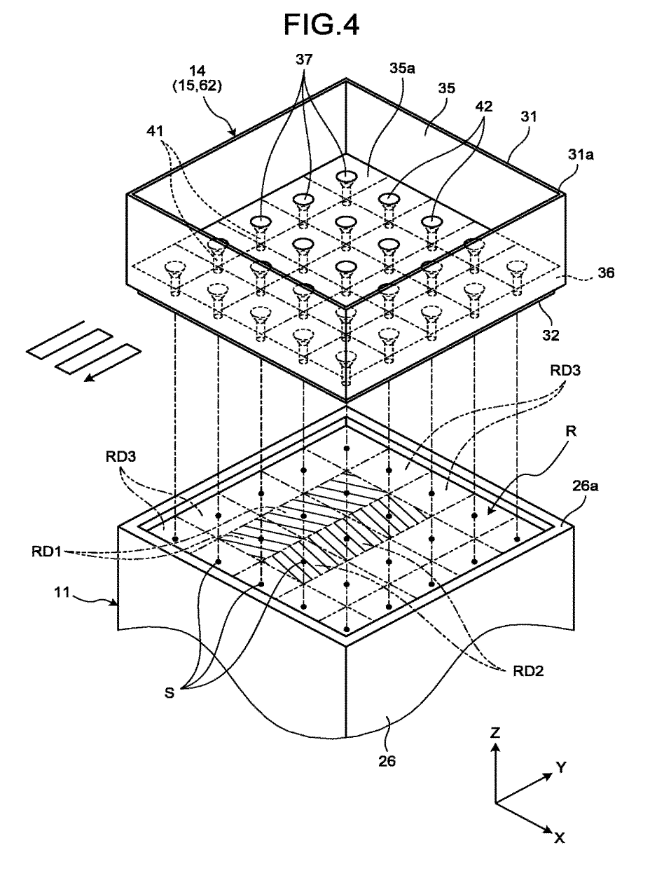

FIG. 3 is a cross-sectional view illustrating a part of the stage 11, and the first material supply device 14 located at the supply position P1. FIG. 4 is a perspective view illustrating a part of the stage 11, and the first material supply device 14 located at the supply position P1. FIG. 4 illustrates a state in which the first material supply device 14 is apart from the stage 11, and a part of the first material supply device 14 is omitted for explanation.

As illustrated in FIG. 3, the first material supply device 14 includes a tank 31, a shutter 32, and a closing unit 33, and a vibrator 34. The closing unit 33 is an example of a switching unit, and for example, may also be referred to as a blocking unit, an adjusting unit or a regulating unit.

The tank 31 is formed in the shape of a substantially quadrangular box. The tank 31 has an upper face 31a and a lower face 31b. The upper face 31a faces upward and is formed to be flat. The lower face 31b is located on the opposite side of the upper face 31a, faces downward and is formed to be flat. When the first material supply device 14 is located at the supply position P1, the lower face 31b faces the upper face 25a of the mounting table 25.

The tank 31 is provided with a containing section 35, a bottom wall 36 and a plurality of supply ports 37. The bottom wall 36 is an example of a first wall and a wall, and for example, may also be referred to as a lower portion or a bottom portion. The plurality of supply ports 37 is an example of an opening, and for example, may also be referred to as a discharge port, a hole or a falling section.

The containing section 35 forms a parallelepiped-shaped recess having a quadrangular shape when viewed in a plan view which is opened to the upper face 31a side of the tank 31. The containing section 35 has a flat bottom face 35a. The bottom face 35a is a quadrangular flat face of 250 mm×250 mm. That is, the area of the bottom face 35a of the containing section 35 is substantially the same as the area of the upper face 25a of the mounting table 25. The shape of the containing section 35 is not limited thereto.

The containing section 35 of the first material supply device 14 contains the powdered material 2. Although the opening portion (the upper end of the containing section 35) of the containing section 35 provided on the upper face 31a of the tank 31 is opened, for example, it may be blocked by an openable and closable lid.

The bottom wall 36 is a quadrangular plate-like section that forms a lower face 31b of the tank 31, and a bottom face 35a of the containing section 35. In other words, the bottom wall 36 is a part of the tank 31 that exists between the lower face 31b of the tank 31 and the bottom face 35a of the containing section 35, and is located below the containing section 35. The material 2 contained in the containing section 35 is supported by the bottom wall 36.

Each of the plurality of supply ports 37 is provided on the bottom wall 36. The plurality of supply ports 37 has substantially the same shape. Each of the supply ports 37 extends in the direction along the Z-axis, and is connected to the containing section 35. Each of the plurality of supply ports 37 has a supply hole 41, and an introduction section 42. The introduction section 42, for example, may also be referred to as a hopper, a funnel section or a conical section.

The supply holes 41 are circular holes that are opened to the lower face 31b of the tank 31. The supply holes 41 are provided from the lower face 31b of the tank 31 to the central portion in the thickness direction of the bottom wall 36. The diameter of the supply holes 41 is six times or more of the particle size of the material 2, and for example, is 0.24 mm. The shape and diameter of the supply holes 41 are not limited thereto.

The introduction section 42 forms a conical recess that is opened to the bottom face 35a of the containing section 35. The introduction section 42 is connected to the supply hole 41. The inner peripheral face of the introduction section 42 is gradually tapered, as it goes toward the lower supply hole 41 from the opening portion provided on the bottom face 35a.

As illustrated in FIG. 4, the supply ports 37 are arranged roughly at equal intervals, in the direction along the X-axis and the direction along the Y-axis. In other words, the supply ports 37 are arranged in a grind point shape. Although the supply ports 37 are arranged in a square grid shape, the supply ports 37 may be arranged in other arrangements such as an oblique grid shape or a regular triangular grid shape. The supply ports 37 are not limited to be arranged in a grid point shape but may be arranged in other arrangements.

An interval (pitch) between the supply port 37 and the other supply port 37 adjacent to the supply port 37, for example, is 1 mm. The pitch between the supply ports 37 is not limited thereto. The opening portion of the introduction section 42 provided on the bottom face 35a of the containing section 35 may be in contact with or spaced apart from the opening portion of the other introduction section 42 adjacent to the introduction section 42.

As illustrated in FIG. 3, the shutter 32 has a shielding wall 45, and a plurality of communication holes 46. The shielding wall 45, for example, may also be referred to as a closing section or a sliding section. The communication holes 46, for example, may also be referred to as communication sections, opened sections or holes.

The shielding wall 45 is a substantially quadrangular plate material which covers the lower face 31b of the tank 31. The shape of the shielding wall 45 is not limited thereto. The shielding wall 45 has an upper face 45a, and a lower face 45b. The upper face 45a is in contact with the lower face 31b of the tank 31. The lower face 45b is located on the opposite side of the upper face 45a, faces downward and is formed to be flat.

When the first material supply device 14 is located at the supply position P1, the lower face 45b of the shielding wall 45 faces the upper face 25a of the mounting table 25. The height (a position in the direction along the Z-axis) of the lower face 45b of the shielding wall 45 is roughly equal to the height of the upper end 26a of the peripheral wall 26. Thus, the shielding wall 45 closes the upper end 26a of the opened peripheral wall 26.

Each of the plurality of communication holes 46 is provided on the shielding wall 45. The communication holes 46 are circular holes which are provided from the upper face 45a to the lower face 45b of the shielding wall 45. The diameter of the communication holes 46 is the same as the diameter of the supply holes 41, and for example, is 0.24 mm. Further, the shape and the diameter of the communication holes 46 are not limited thereto, and for example, the diameter of the communication holes 46 may be different from the diameter of the supply holes 41.

As with the supply port 37, the plurality of communication holes 46 is arranged roughly at equal intervals, in the direction along the X-axis and the direction along the Y-axis. An interval (pitch) between the communication hole 46 and the other communication hole 46 adjacent to the communication hole 46, for example, is 1 mm, like the interval of the supply port 37. That is, the plurality of communication holes 46 is arranged in the same direction and at the same interval as the plurality of supply ports 37.

The shielding wall 45, for example, is movable in the X-axis direction along the bottom wall 36, by a variety of devices such as actuators. The movement direction of the shielding wall 45 is not limited thereto. The shielding wall 45, for example, moves between an opened position P5 and a closed position P6. FIGS. 3 and 4 illustrate the shielding wall 45 which is located at the opened position P5.

When the shielding wall 45 is located at the opened position P5, each of the plurality of communication holes 46 communicates with the supply holes 41 of the plurality of supply ports 37. That is, each of the supply holes 41 is opened by the corresponding communication holes 46.

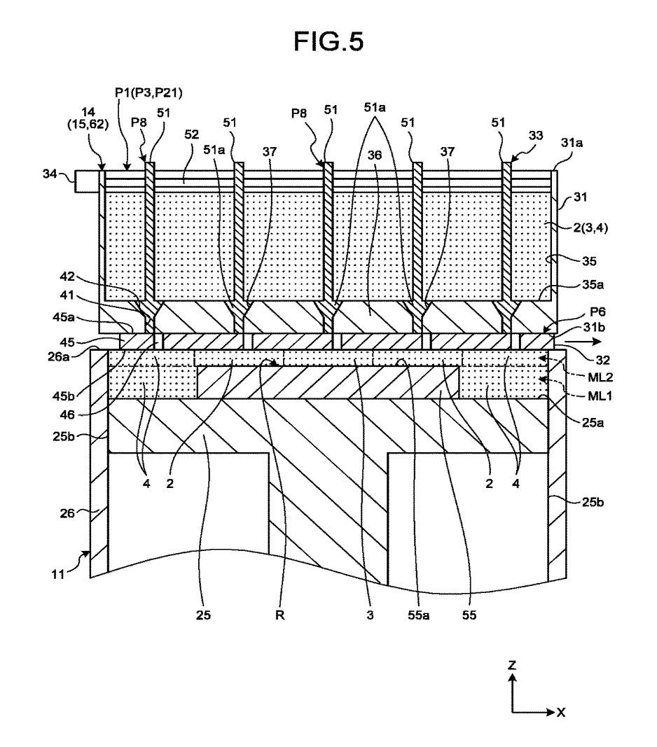

FIG. 5 is a cross-sectional view illustrating a part of the stage 11, and the first material supply device 14 in which the shielding wall 45 is located at the closed position P6. Since the second material supply device 15 and the third material supply device 62 have the same configuration as that of the first material supply device 14 as it will be described later, FIG. 5 also illustrates the second material supply device 15 and the third material supply device 62.

As illustrated in FIG. 5, when the shielding wall 45 is located at the closed position P6, the position of the plurality of communication holes 46 deviates from the supply holes 41 of the corresponding supply ports 37. Therefore, the shielding wall 45 located at the closed position P6 closes the supply holes 41 of the plurality of supply ports 37.

The closing unit 33 has a plurality of pistons 51, and a support member 52. Further, the closing unit 33 is omitted in FIG. 4. The piston 51, for example, may also be referred to as a structure, an extruding unit, a pressing unit, an inserting unit or a plug. The support member 52 may also be referred to as a connecting unit or a moving unit.

The piston 51 is formed in a rod shape extending in a direction along the Z-axis. A valve section 51a is provided at one end portion of the piston 51. The valve section 51a has a shape corresponding to the supply port 37. That is, the valve section 51a has a rod-like portion that can be fitted into the supply hole 41, and a conical section that can be fitted into the introduction section 42.

The piston 51 is disposed within the containing section 35 such that the valve section 51a faces the corresponding supply port 37. The valve section 51a of the piston 51 is buried in the material 2 which is contained in the containing section 35. Further, the valve section 51a may be located outside the containing section 35.

The support member 52 supports the plurality of pistons 51. The plurality of pistons 51 supported by the support member 52 is arranged roughly at equal intervals, in the direction along the X-axis and the direction along the Y-axis. That is, the plurality of pistons 51 is arranged in the same way and at the same interval as the plurality of supply ports 37.

The support member 52 is able to individually move the plurality of pistons 51 in the direction along the Z-axis, by a variety of devices such as actuators. In other words, the support member 52 individually moves the piston 51 provided with the valve section 51a in the direction intersecting with the bottom wall 36.

As illustrated in FIG. 3, the plurality of pistons 51, for example, individually moves between an opened position P7 and a closed position PB. The piston 51 located at the opened position P7 is spaced apart from the supply port 37. In other words, the valve section 51a of the piston 51 located at the opened position P7 opens the supply port 37 by deviating from the corresponding supply port 37.

The valve section 51a of the piston 51 located at the closed position PB is fitted to the corresponding supply port 37. The conical section of the valve section 51a is brought into close contact with the introduction section 42. In this way, the valve section 51a moved to the closed position P8 closes the supply port 37.

When the plurality of pistons 51 is individually moved between the opened position P7 and the closed position P8, the plurality of pistons 51 individually opens and closes the corresponding supply ports 37. The opening and closing of each piston 51, for example, are controlled by the control unit 19.

The first material supply device 14 is moved to the supply position P1 by the first moving device 12. When the first material supply device 14 is located at the supply position P1, the shielding wall 45 is moved to the opened position P5. In other words, the supply holes 41 of the plurality of supply ports 37 are opened by the corresponding communication holes 46.

Further, when the first material supply device 14 is located at the supply position P1, the plurality of pistons 51 is selectively moved to the opened position P7. That is, the piston 51 selected by the control unit 19 is individually moved to the opened position P7, and the other piston 51 remains at the closed position P8. In other words, the supply ports 37 are individually opened by the corresponding pistons 51.

The powdered material 2 contained in the containing section 35 drops by gravity from the supply port 37 opened by the communication hole 46 and the piston 51 through the communication hole 46 communicating with the supply port 37. The material 2 of the containing section 35 is guided to the supply hole 41, by the inclined inner circumferential face of the introduction section 42. A drop amount of powder per unit time is substantially constant, regardless of the height of the material 2 contained in the containing section 35, like an hourglass.

Further, the containing section 35 may be provided with a partition plate corresponding to the supply port 37. The partition plate divides the material 2 contained in containing section 35, so that the material 2 is uniformly guided to the introduction section 42 of the corresponding supply port 37.

The vibrator 34, for example, is a motor which turns an eccentric weight. The first material supply device 14 is vibrated by the vibrator 34. The first material supply device 14 facilitates the dropping of the material 2 of the containing section 35 from the plurality of supply ports 37 and the plurality of communication holes 46 by vibrating. The first material supply device 14 may not include the vibrator 34. Even when there is no vibration caused by the vibrator 34, the material 2 drops from the plurality of supply ports 37 and the plurality of communication holes 46 by gravity.

Since the second material supply device 15 and the third material supply device 62 have the same structure as that of the first material supply device 14, a detailed description thereof will not be provided. Further, the second material supply device 15 and the third material supply device 62 may have a structure different from that of the first material supply device 14. The containing section 35 of the second material supply device 15 contains the material 3, unlike the containing section 35 of the first material supply device 14. The containing section 35 of the third material supply device 62 contains the material 4, unlike the containing section 35 of the first material supply device 14.

The optical device 16 illustrated in FIG. 1 has various components such as a light source which emits a laser beam L having an oscillation element, a conversion lens which converts the laser beam L into a parallel light, a convergence lens which converges the laser beam L, and a galvanometer mirror which moves the irradiation position of the laser beam L. The optical device 16 is capable of changing the power density of the laser beam L. In the present embodiment, the laser beam L is used as the energy rays. As the energy rays, as long as it is possible to melt or sinter the materials 2 and 3, the laser beam L or the like may be used, and an electron beam or an electromagnetic wave of ultraviolet region from microwave may be used.

The optical device 16 is located above the stage 11. The optical device 16 may be disposed in other locations. The optical device 16 converts the laser beam L emitted from the light source into the parallel light by the conversion lens. The optical device 16 reflects the laser beam L to the galvanometer mirror capable of changing the inclination angle, and makes the laser beam L converge by the convergence lens, thereby irradiating a desired position with the laser beam L.

The first material replenishing device 17 may contains more material 2 than the containing section 35 of the first material supply device 14. The first material replenishing device 17 is disposed above the standby position P2, and has an openable and closable lid. When the first material supply device 14 is located at the standby position P2, the lid faces the containing section 35 which is opened to the upper face 31a of the tank 31.

When the first material supply device 14 is located at the standby position P2, the first material replenishing device 17 opens the lid, and supplies the material 2 to the containing section 35. When the first material supply device 14 is not located at the standby position P2, the first material replenishing device 17 prevents the material 2 from dropping, by closing the lid.

The second material replenishing device 18 can contain more material 3 than the containing section 35 of the second material supply device 15. The second material replenishing device 18 is disposed above the standby position P4, and has an openable and closable lid. When the second material supply device 15 is located at the standby position P4, the lid faces the containing section 35 which is opened to the upper face 31a of the tank 31.

When the second material supply device 15 is located at the standby position P4, the second material replenishing device 18 opens the lid, and supplies the material 3 to the containing section 35. When the second material supply device 15 is not located at the standby position P4, the second material replenishing device 18 prevents the material 3 from dropping, by closing the lid.

The third material replenishing device 63 can contain more material 4 than the containing section 35 of the third material supply device 62. The third material replenishing device 63 is disposed above the standby position P22, and has an openable and closable lid. When the third material supply device 62 is located at the standby position P22, the lid faces the containing section 35 which is opened to the upper face 31a of the tank 31.

When the third material supply device 62 is located at the standby position P22, the third material replenishing device 63 opens the lid, and supplies the material 4 to the containing section 35. When the third material supply device 62 is not located at the standby position P22, the third material replenishing device 63 prevents the material 4 from dropping, by closing the lid.

The control unit 19 is electrically connected to the stage 11, the first moving device 12, the second moving device 13, the third moving device 61, the first material supply device 14, the second material supply device 15, the third material supply device 62, the optical device 16, the first material replenishing device 17, the second material replenishing device 18 and the third material replenishing device 63. The control unit 19, for example, has various electronic components such as a CPU, a ROM and a RAM. The control unit 19 controls the stage 11, the first moving device 12, the second moving device 13, the third moving device 61, the first material supply device 14, the second material supply device 15, the third material supply device 62, the optical device 16, the first material replenishing device 17, the second material replenishing device 18 and the third material replenishing device 63, by reading and executing a program stored in the ROM or other storage devices. The additive manufacturing apparatus 1 manufactures the additive manufactured object 5, based on the control (program) of the control unit 19.

An example of a procedure (a method for manufacturing the additive manufactured object 5) for manufacturing the additive manufactured object 5 by the additive manufacturing apparatus 1 will be described below. The method for manufacturing the additive manufactured object 5 by the additive manufacturing apparatus 1 is not limited to that described below.

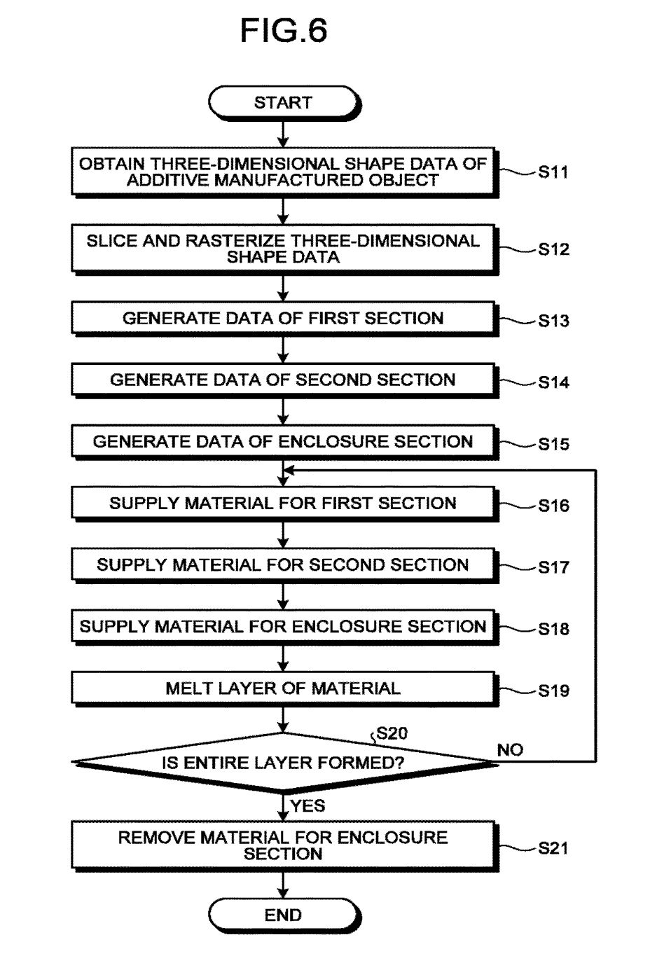

FIG. 6 is a flowchart illustrating an example of a procedure for manufacturing the additive manufactured object 5. First, a data of a three-dimensional shape of the additive manufactured object 5 is input to the control unit 19 of the additive manufacturing apparatus 1, for example, from an external personal computer, and the control unit 19 obtains the data of the three-dimensional shape of the additive manufactured object 5 (S11). The data of the three-dimensional shape, for example, is the data of CAD, but is not limited thereto.

The data of the three-dimensional shape includes information about the materials which form the respective portions of the additive manufactured object 5. That is, the data of the three-dimensional shape includes information about a section formed by the material 2 of the additive manufactured object 5 (hereinafter, referred to as first section 5a), and a section formed by the material 3 of the additive manufactured object 5 (hereinafter, referred to as a second section 5b). The material 2 may be referred to as a material for the first section 5a, and the material 3 may be referred to as a material for the second section 5b.

Next, the control unit 19 divides (slices) the three-dimensional shape of the obtained data into a plurality of layers. The control unit 19 converts (rasterizes, and pixelates) the sliced three-dimensional shape, for example, into a collection of a plurality of points and rectangular parallelepipeds (pixels). In this way, the control unit 19 generates the data of a plurality of layers of two-dimensional shape, from the obtained data of the three-dimensional shape of the additive manufactured object 5 (S12). The generated data is stored in a storage unit (not illustrated) of the control unit 19.

An interval (pitch) of the plurality of pixels included in the data of the layer of the two-dimensional shape corresponds to the interval (pitch) of the supply ports 37 of the first, second and third material supply devices 14, 15 and 62. That is, when the pitch of the supply ports 37 is 1 mm, each pixel of the data of the layer is a quadrangle of 1 mm×1 mm. Further, the pitch of the pixel is not limited thereto.

Next, the control unit 19 divides the data of the plurality sliced layers of the two-dimensional shape into the data of the section formed by the material 2, and the data of the section formed by the material 3. That is, the control unit 19 generates data of the first section 5a in each layer (S13). Furthermore, the control unit 19 generates data of the second section 5b in each layer (S14). The generated data is stored in the storage unit of the control unit 19. Further, the control unit 19 generates the data of a section formed by the material 4 (hereinafter, also referred to as an enclosure section), among the layers (material layer) to be laminated on the mounting table 25, using the generated data of the first section 5a and the generated data of the second section 5b (S15). The section (the enclosure section) of the material 4 among the layers to be laminated on the mounting table 25 is a section other than the sections of the materials 2 and 3 among the layers. The material 4 may also be referred to as a material for the enclosure section.

Next, the first material replenishing device 17 supplies the material 2 to the containing section 35 of the first material supply device 14 which is located at the standby position P2. The control unit 19, for example, measures the weight of the material 2 contained in the containing section 35 by the sensor, and until the weight reaches a certain value, the control unit 19 causes the first material replenishing device 17 to supply the material 2 to the containing section 35. Thus, the containing section 35 contains a certain amount of material 2. Further, when the containing section 35 already contains a certain amount of material 2, the supply of the material 2 using the first material replenishing device 17 may be omitted.

Similarly, the second material replenishing device 18 supplies the material 3 to the containing section 35 of the second material supply device 15 which is located at the standby position P4. Further, when the containing section 35 contains a certain amount of material 3 in advance, the supply of the material 3 using the second material replenishing device 18 may be omitted. Also, the third material replenishing device 63 supplies the material 4 to the containing section 35 of the third material supply device 62 which is located at the standby position P22. Further, when the containing section 35 already contains a certain amount of material 4, the supply of the material 4 using the third material replenishing device 63 may be omitted.

The shielding wall 45 of the first material supply device 14 is usually located at the closed position P6. Furthermore, the piston 51 of the first material supply device 14 is usually located at the closed position P8. Therefore, the supply ports 37 are closed by the shielding wall 45 and the piston 51, and the material 2 contained in the containing section 35 is prevented from dropping from the supply ports 37. Similarly, dropping of the material 3 is also prevented in the second material supply device 15, and dropping of the material 4 is also prevented in the third material supply device 62.

Next, the first moving device 12 moves the first material supply device 14 to the supply position P1 from the standby position P2. The first material supply device 14 supplies the material 2 for the first section 5a to the top of the stage 11 as described below, when reaching the supply position P1 (S16).

As illustrated in FIG. 3, a base 55 is mounted on and fixed to the upper face 25a of the mounting table 25 of the stage 11. The base 55 is provided to manufacture the additive manufactured object 5 on the top of the base 55. Further, the additive manufactured object 5 may also be directly manufactured on the upper face 25a of the mounting table 25, rather than placing the base 55 on the upper face 25a of the mounting table 25.

The base 55, for example, is a quadrangular plate material. The shape of the base 55 is not limited thereto, and is determined by the shape of the additive manufactured object 5. The base 55 has a flat upper face 55a. The upper face 55a of the base 55 is parallel to the upper face 25a of the mounting table 25.

Initially, the mounting table 25 of the stage 11 is disposed so that a distance between the upper face 55a of the base 55 and the upper end 26a of the peripheral wall 26 in the direction along the Z-axis is 50 μm. Therefore, the distance between the upper face 55a of the base 55 and the lower face 45b of the shielding wall 45 of the first material supply device 14 located at the supply position P1 is 50 μm.

The material 4 is laid around the base 55 in advance. The face 4a of the laid material 4 forms substantially the same plane as the upper face 55a of the base 55. Accordingly, the material 4 and the base 55 form a single layer ML1 on the upper face 25a of the mounting table 25.

The face 4a of the material 4 forming the layer ML1, and the upper face 55a of the base 55 form a supply region R. The supply region R is an example of a region to which the material is supplied. As it will be described later, the supply region R is also formed by a plurality of layers ML2, ML3, ML4 and the like laminated on the layer ML1.

The supply region R is a substantially quadrangular flat plane of 250 mm×250 mm, like the upper face 25a of the mounting table 25. The shape of the supply region R may be different from the shape of the upper face 25a of the mounting table 25. A distance between the supply region R and the lower face 45b of the shielding wall 45 of the first material supply device 14 located at the supply position P1 is 50 μm. Further, a distance between the supply region R and the lower face 45b of the shielding wall 45 may be modified to 30 μm and 100 μm, by controlling the mounting table 25 using the control unit 19. The supply region R is surrounded by the peripheral wall 26.

The bottom wall 36 of the first material supply device 14 located at the supply position P1 is located above the supply region R. The bottom wall 36 covers the entire region of the supply region R. Further, the bottom wall 36 may partially cover the supply region R. The lower face 31b of the tank 31 and the lower face 45b of the shielding wall 45 are directed to the supply region R.

As illustrated in FIG. 4, in the present embodiment, the supply region R is defined as having a plurality of divided compartments RD1, RD2 and RD3. The plurality of divided compartments RD1, RD2 and RD3 is an example of a plurality of compartments. The plurality of divided compartments RD1, RD2 and RD3, for example, is a quadrangular compartment. The divided compartments RD1, RD2 and RD3 are not limited to thereto, and may have other shapes.

The areas of the plurality of divided compartments RD1, RD2 and RD3 are equal to each other. Each of the plurality of divided compartments RD1, RD2 and RD3 is arranged in the direction along the X-axis and in the direction along the Y-axis. The plurality of supply ports 37 and the plurality of communication holes 46 are directed to the corresponding divided compartments RD1, RD2 and RD3. That is, the supply ports 37 and the communication holes 46 are located above the corresponding divided compartments RD1, RD2 and RD3, and are opposite to (face) the divided compartments RD1, RD2 and RD3.

The divided compartment RD1 corresponds to the data of the first section 5a in each layer generated by the control unit 19. That is, a plurality of pixels that forms the data of the first section 5a corresponds to a plurality of divided compartments RD1.

The divided compartment RD2 corresponds to the data of the second section 5b in each layer generated by the control unit 19. That is, a plurality of pixels that forms the data of the second section 5b corresponds to a plurality of divided compartments RD2. In FIG. 4, the divided compartment RD2 is illustrated by being hatched.

The divided compartment RD3 corresponds to the section other than the divided compartment RD1 and the divided compartment RD2. That is, a plurality of pixels which forms the data of a section (enclosure section) other than the first section 5a and the second section 5b corresponds to the plurality of divided compartments RD3.

As illustrated in FIG. 3, when the first material supply device 14 reaches the supply position P1, the control unit 19 moves the shielding wall 45 to the opened position P5. In this way, the communication hole 46 of the shutter 32 communicates with the supply hole 41 of the supply port 37.

Further, the control unit 19 moves the piston 51, which closes the supply port 37 corresponding to the divided compartment RD1, to the opened position P7. In this way, the supply port 37 corresponding to the divided compartment RD1 is opened by the communication hole 46 and the piston 51. In other words, only the supply port 37 opposite to the divided compartment RD1 is opened. Further, the supply port 37 corresponding to the divided compartment RD2 is still closed by the piston 51.

The first material supply device 14 is vibrated by the vibrator 34. The material 2 of the containing section 35 drops into the supply region R, through a plurality of supply ports 37 and a plurality of communication holes 46 that are opened by the piston 51. The first material supply device 14 supplies the material 2 to the supply region R in parallel, from at least one opened supply port 37.

Each of the plurality of opened supply ports 37 supplies the material 2 to the corresponding divided compartments RD1. FIG. 4 illustrates drop points S of the material 2 which has dropped from the respective supply ports 37 and the respective communication holes 46. The drop points S are located within the divided compartment RD1 which corresponds to the respective opened supply ports 37 and communication holes 46.

While supplying the material 2 to the supply region R from the plurality of supply ports 37 and the plurality of communication holes 46, the first material supply device 14 is moved in the direction along the X-axis and the direction along the Y-axis as illustrated by the arrow in FIG. 4, for example, by the first moving device 12. As a result, the drop points S of the material 2 dropping from each supply port 37 and each communication hole 46 move in the corresponding divided compartments RD1 as illustrated by the arrow in FIG. 4. The drop points S move in the divided compartment RD1 to trace in a single stroke. Therefore, the material 2 is substantially uniformly supplied to each of the divided compartments RD1.

By supplying the material 2 to each of the divided compartments RD1, the layer of the material 2 is partially formed in the supply region R. In other words, a layer of the material 2 is laminated on the layer ML1.

When the material 2 is supplied to the supply region R, the supplied material 2 comes into contact with the lower face 45b of the shielding wall 45. At a position to which the material 2 is supplied, the communication holes 46 are closed by the material 2.

The control unit 19 counts an elapsed time after the shielding wall 45 moves to the opened position P5 and the supply ports 37 are opened, for example, by a timer. When a certain time has passed after the supply port 37 is opened, the control unit 19 moves the shielding wall 45 from the opened position Pb to the closed position P6, and causes the shielding wall 45 to close the supply ports 37. Since the drop speed of the powder passing through the supply ports 37 is substantially constant, it is possible to control the drop amount by the opening time of the supply ports 37.

Meanwhile, a plurality of pistons 51 moved to the opened position P7 gradually moves toward the closed position P8. The valve section 51a of the piston 51 moved to the closed position PB from the opened position P7 pushes the material 2 located between the valve section 51a and the supply port 37 toward the supply port 37. Thus, the material 2 is extruded from the supply port 37 by the piston 51, and is supplied to the supply region R.

When a certain time passes after the plurality of pistons 51 moves to the opened position P7, the plurality of pistons 51 moving toward the closed position P8 reaches the closed position P8. The material 2 in the supply hole 41 is extruded from the supply hole 41, by the valve section 51a of the piston 51.

As illustrated in FIG. 5, the valve section 51a of the piston 51, which has reached the closed position P6, closes the supply port 37 by being fitted to the supply port 37. That is, when a certain time passes after the piston 51 opens the supply port 37, the valve section 51a of the piston 51 closes the supply port 37. Thus, the material 2 is supplied to the supply region R. Further, the piston 51 closes the supply port 37, before the shielding wall 45 closes the supply port 37.

When the layer of the material 2 is formed in the supply region R as described above, the lower face 45b of the shielding wall 45 press the face of the material 2. As a result, the supplied material 2 is leveled. After the layer of the material 2 is formed, the first moving device 12 moves the first material supply device 14 to the standby position P2 from the supply position P1.

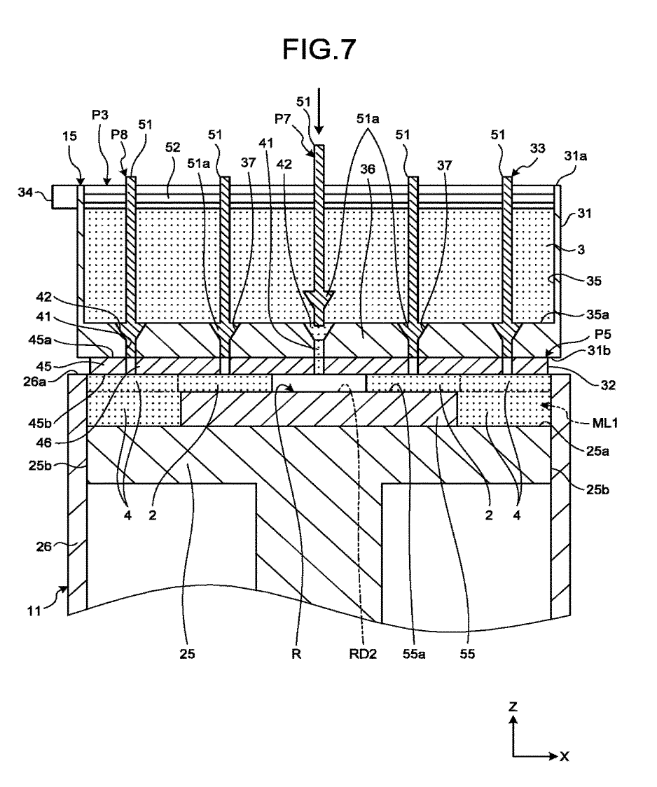

Next, the second moving device 13 moves the second material supply device 15 to the supply position P3 from the standby position P4. FIG. 7 is a cross-sectional view illustrating a part of the stage 11, and the second material supply device 15. As illustrated in FIG. 7, as with the first material supply device 14, when reaching the supply position P3, the second material supply device 15 supplies the material 3 for the second section 5b to the top of the stage 11 (S17).

The control unit 19 moves the piston 51, which closes the supply port 37 corresponding to the divided compartment RD2, among the plurality of pistons 51 of the second material supply device 15, to the opened position P7. Thus, the supply port 37 corresponding to the divided compartment RD2 is opened by the communication hole 46 and the piston 51. In other words, only the supply port 37 opposite to the divided compartment RD2 is opened. Further, the supply port 37 corresponding to the divided compartments RD1 and RD3 are still closed by the piston 51.

The material 3 contained in the containing section 35 of the second material supply device 15 drops into the supply region R, through a plurality of supply ports 37 and a plurality of communication holes 46 that are opened by the piston 51. The second material supply device 15 supplies the material 3 to the supply region R in parallel, from at least one opened supply port 37.

Each of the plurality of opened supply ports 37 supplies the material 3 to the corresponding divided compartment RD2. As illustrated in FIG. 5, by supplying the material 3 to each of the divided compartments RD2, a series of layers ML2 is formed in the supply region R, by the material 2 and the material 3. In other words, the layer of the material 2 and the layer of the material 3 are combined to form the layers of the materials 2 and 3.

When the layers of the material 2 and the material 3 are formed, the lower face 45b of the shielding wall 45 presses the faces of the layers. As a result, the faces of the formed layers of the material 2 and the material 3 are leveled. Next, the second moving device 13 moves the second material supply device 15 to the standby position P4 from the supply position P3.

Next, the third moving device 61 moves the third material supply device 62 to the supply position P21 from the standby position P22. As with the first material supply device 14, the third material supply device 62 supplies the material 4 for the enclosure section to the top of the stage 11, when reaching the supply position P21 (S18).

The control unit 19 moves the piston 51, which closes the supply port 37 corresponding to the divided compartment RD3, among the plurality of pistons 51 of the third material supply device 62, to the opened position P7. As a result, the supply port 37 corresponding to the divided compartment RD3 is opened by the communication hole 46 and the piston 51. In other words, only the supply port 37 opposite to the divided compartment RD3 is opened. The supply ports 37 corresponding to the divided compartments RD1 and RD2 are still closed by the piston 51.

The material 4 contained in the containing section 35 of the third material supply device 62 drops into the supply region R, through a plurality of supply ports 37 and a plurality of communication holes 46 that are opened by the piston 51. The third material supply device 62 supplies the material 4 to the supply region R in parallel, from at least one opened supply port 37.

Each of the plurality of opened supply ports 37 supplies the material 4 to the corresponding divided compartment RD3. As illustrated in FIG. 5, when the material 4 is supplied to each of the divided compartments RD3, a series of layers ML2 is formed in the supply region R by the materials 2 to 4. In other words, the layer of the material 2, the layer of the material 3 and the layer of the material 4 are combined to form the layer ML2 of the materials 2 to 4. Further, the amounts of the material 2, the material 3 and the material 4 to be supplied to each of the divided compartments RD1, RD2 and RD3 are substantially the same. Therefore, the thickness of the layer ML2 formed in the supply region R is substantially the same, regardless of the position.

When the layer ML2 is formed, the lower face 45b of the shielding wall 45 presses the face of the layer ML2. Thus, the face of the formed layer ML2 is leveled. After the layer ML2 is formed, the third moving device 61 moves the third material supply device 62 to the standby position P22 from the supply position P21. When the third material supply device 62 is moved to the standby position P22 from the supply position P21, the lower face 45b of the shielding wall 45 may level the face of the layer ML2, by rubbing the face of the layer ML2 which is in contact with the lower face 45b.

Next, as illustrated in FIG. 1, the control unit 19 irradiates the region including the materials 2 and 3 forming the layer ML2 with the laser beam L of the optical device 16, by controlling the optical device 16 (S19). The control unit 19 determines the irradiation position of the laser beam L, based on the input data of the three-dimensional shape of the additive manufactured object 5.

A portion of the layer ML2 irradiated with the laser beam L is melted. In other words, the materials 2 and 3 are cured after being melted, by irradiation with the laser beam L. That is, the materials 2 and 3 are solidified. As a result, a part (a single layer) of the additive manufactured object 5 is formed on the layer ML2. A part of the additive manufactured object 5 to be formed corresponds to the data of the layer of the two-dimensional shape generated by the control unit 19. The materials 2 and 3 may be sintered, and may be solidified by sintering.

While the layer ML2 is irradiated with the laser beam L, the first material replenishing device 17 supplies the material 2 to the containing section 35 of the first material supply device 14. Similarly, the second material replenishing device 18 supplies the material 3 to the containing section 35 of the second material supply device 15, and the third material replenishing device 63 supplies the material 4 to the containing section 35 of the third material supply device 62. The volume of the materials 2 to 4 each contained in the containing section 35 is larger than the volume of the layer ML2 formed in the supply region R.

When the optical device 16 finishes the irradiation of the layer ML2 with the laser beam L, the mounting table 25 moves downward, for example, in the amount of 50 μm. The movement distance of the mounting table 25 is equal to the thickness of the layer ML2. Thus, the distance between the face of the layer ML2 and the upper end 26a of the peripheral wall 26 becomes 50 μm.

The face of the layer ML2 forms the supply region R of the layer ML2. When the additive manufactured object 5 is not completed (S20: NO), the first moving device 12 moves the first material supply device 14 to the supply position P1 again. The first material supply device 14 supplies the material 2 to the supply region R formed by the layer ML2 at the supply position P1 (S16).

FIG. 8 is a cross-sectional view illustrating a stage 11 in which the additive manufactured object 5 is manufactured. As with the above description, the first material supply device 14, the second material supply device 15 and the third material supply device 62 supply the materials 2 to 4 to the supply region R (S16, S17 and S18) to sequentially form a plurality of layers ML2, ML3, ML4 and the like of the materials 2 to 4 as illustrated in FIG. 8. In FIG. 8, the layers ML2, ML3, ML4 and the like are partitioned by the two-dot chain lines.

Each time the layers ML2, ML3, ML4 and the like are formed, the optical device 16 melts the materials 2 and 3 of the layers ML2, ML3, ML4 and the like by irradiation with the laser beam L to form a part of the additive manufactured object 5 (S19). The materials 2 and 3 of each of the layers ML2, ML3, ML4 and the like constitute a layer 5c. The additive manufacturing apparatus 1 solidifies the molten materials 2 and 3, by finishing the irradiation with the laser beam L with respect to the molten materials 2 and 3. The additive manufactured object 5 includes a first section 5a formed by the material 2 solidified after melting, and a second section 5b formed by the material 3 solidified after melting.

The additive manufacturing apparatus 1 manufactures the additive manufactured object 5 of the three-dimensional shape, by repeating the formation of the layers ML2, ML3, ML4 and the like and melting of the materials 2 and 3 using the optical device 16 to laminate a plurality of layers 5c. When each section (each layer 5c) of the additive manufactured object 5 corresponding to all the data of the layer of the two-dimensional shape generated by the control unit 19 is formed (S20: YES), the manufacturing of the additive manufactured object 5 is completed.

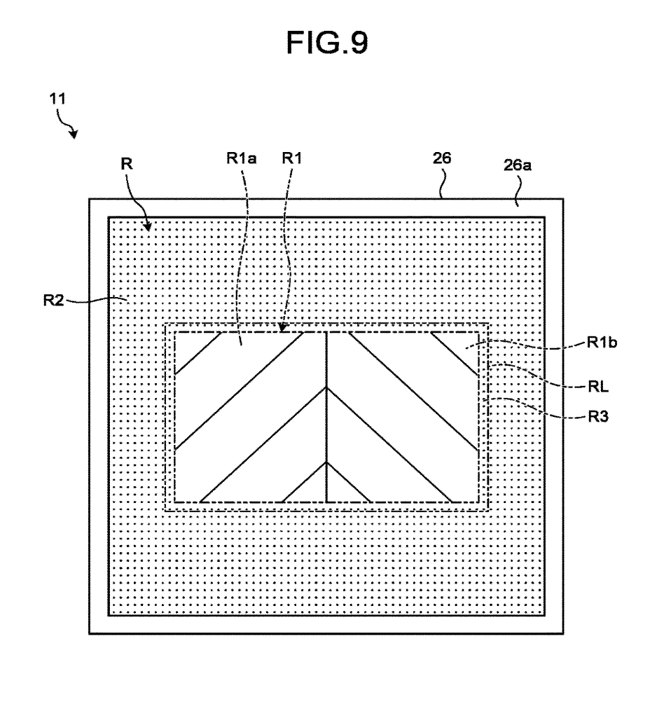

Here, the supply region R, and the region which is irradiated with the laser beam L (hereinafter, referred to as an irradiation region) RL will be described. FIG. 9 is a plan view illustrating the supply region R. The supply region R has a region R1 to which at least one of the material 2 and the material 3 is supplied, and a region R2 to which the material 4 is supplied. As an example, as a plurality of different materials, both of the material 2 and the material 3 are supplied to the region R1. That is, in the example illustrated in FIG. 9, the region R1 has a region R1a to which the material 2 is supplied, and a region R1b to which the material 3 is supplied. Further, the region R2 surrounds at least a part (as an example, all parts) of the region R1. The region R2 is adjacent to the region R1. The region R1a is made up of one or a plurality of divided compartments RD1, the region R1b is made up of one or a plurality of divided compartments RD2, and the region R2 is made up of one or a plurality of divided compartments RD3. Further, in FIG. 9, the irradiation region RL of the laser beam L is a region which is surrounded by the outer dashed line of the dual two-dot chain lines. In addition, in FIG. 9, the region R1a the region Rib and the region R2 are illustrated by each of different hatchings. The region R1 is an example of the first region, and the region R2 is an example of the second region.

The irradiation region RL is made up of the region R1 and the region R3. The region R3 is a region which is a part of the region R2 and is adjacent to the region R1. The region R3 is an example of a third region. The region R3 is formed in an annular form that surrounds the region R1. In FIG. 9, the region R3 is a region between the double two-dot chain lines. The irradiation region RL, that is, the region R1 and the region R3 are irradiated with the laser beam L. The materials 2 and 3 in the region R1 are melted by the laser beam L and are solidified after melting. However, even if the material 4 in the region R3 is irradiated with the laser beam L, since the laser beam L is transmitted through the material 4, the material 4 is not melted. Therefore, the material 4 in the region R3 is not solidified. Further, solidification may be performed by sintering. In the present embodiment, since the region R3 is a boundary adjacent to the region R1 (a manufacturing range of the additive manufactured object 5), the region R3 is a section that is not desired to solidify the material 4.

When all the materials 2 and 3 are solidified and the manufacturing of the additive manufactured object 5 is completed (S20: Yes), the control unit 19 removes the powdered material 4 for the enclosure section that surrounds the additive manufactured object 5 (S21). The powdered material 4, for example, is removed by suction or free fall, and is recovered in a tank that contains the material 4. The recovered material 4 is supplied to the third material replenishing device 63 and is reused. The suction of the material 4 can be performed, for example, by a suction device. Moreover, the free fall of the material 4 can be performed by providing the mounting table 25 with a mechanism for dropping the material 4. The additive manufactured object 5 is taken out by removing the powdered material 4. Further, the powdered material 4 adhering to (remaining on) the face of the additive manufactured object 5, that is, the faces of the solidified materials 2 and 3 is removed, for example, by various processes such as polishing, cutting and laser machining.

The additive manufactured object 5 manufactured inside the processing tank 10 is taken out from the processing chamber 10a, for example, by opening a cover provided in the processing tank 10. However, the additive manufactured object 5, for example, may be conveyed out of the processing chamber 10a by a conveying device having a conveying arm or the like, without being limited thereto. The additive manufactured object 5, for example, is conveyed to a chamber (an auxiliary chamber) isolated from the processing chamber 10a, by an openable and closable lid.

In the present embodiment, the powdered materials 2 and 3 (the first material) capable of being melted or sintered by the irradiation with the laser beam L (energy rays) are supplied, the powdered material 4 through which the laser beam L is transmitted (the second material) is supplied, the materials 2 and 3 are melted or sintered by irradiation with the laser beam L, and the materials 2 and 3 are solidified after melting or are solidified by sintering. Since the laser beam L is transmitted through the material 4, the material 4 is not melted and solidified even when the laser beam L is irradiated. Therefore, by the use of the material 4 in the portion (region R3) which is not desired to be solidified among the supplied materials 2 to 4, it is possible to suppress the solidification of the portion which is not desired to be the solidified. Further, since the portion (region R3) which is not desired to be solidified is also irradiated with the laser beam L, it is possible to irradiate all the materials 2 and 3 of the region R1 with the laser beam L. Therefore, it is possible to use substantially all of the materials 2 and 3.

Further, in the present embodiment, the materials 2 and 3 are supplied to the region R1 (the first region), and the material 4 is supplied to the region R2 (the second region) adjacent to the region R1. Therefore, it is possible to support at least some of the materials 2 and 3 by the material 4.

Further, in the present embodiment, the materials 2 and 3 as a plurality of different materials are supplied to the region R1. Thus, the additive manufactured object 5 made up of the different materials 2 and 3 is obtained.

Further, in the present embodiment, the region R1, and the region R3, which is a part of the region R2 and is adjacent to the region R1 are irradiated with the laser beam L. Thus, by setting the irradiation region RL of the laser beam L irrespective of the manufacturing range of the additive manufactured object 5, it is also possible to irradiate a boundary between a manufacturing range (the region R1) of the additive manufactured object 5 and the outside (the region R2) of the range of the manufacturing range of the additive manufactured object 5 with the laser beam L having the wider optical diameter.

Further, in the present embodiment, after the materials 2 and 3 are solidified, the material 4 is removed. Since the material 4 is not melted and solidified even when irradiated with the laser beam L, it is possible to comparatively easily perform the removal of the material 4. Further, since the material 4 is not melted and solidified even when irradiated with the laser beam L, it is easy to reuse the removed material 4. Further, since substantially all the materials 2 and 3 can be used, it is possible to eliminate the work of removing the materials 2 and 3 and to reuse the material 4.

In the present embodiment, although an example in which the material 4 is laid around the base 55 in advance in the production of the additive manufactured object 5 has been described, the invention is not limited thereto. For example, a metal block or the like may be laid around the base 55 in advance. Further, the supply of the materials 2 to 4 may start from the supply of the material 4, and the material 4 may be laid around the base 55.

In the production of the additive manufactured object 5, the order of supply of the materials 2 to 4 is not limited to the order illustrated in FIG. 6. That is, each material supplied first, second and third may be any one of the materials 2 to 4, and may be different from each other.

Further, in the present embodiment, although an example in which the first materials are two (materials 2 and 3) has been described, but is not limited thereto. The first material may be one or three or more. In this case, a configuration (the material supply device, the moving device and the material replenishing device) for supplying the first material for each first material may be provided.

### Second Embodiment

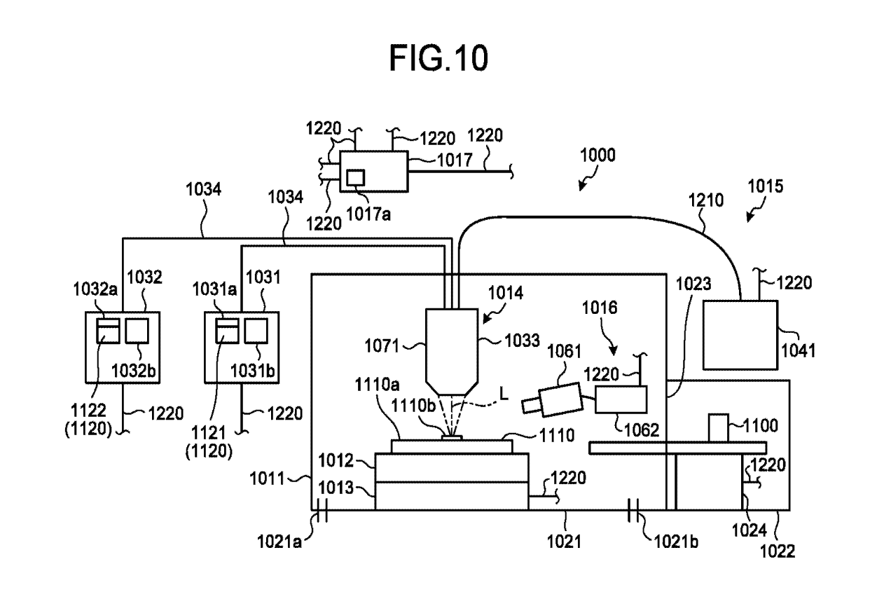

Next, a second embodiment will be described with reference to FIGS. 10 to 16. FIG. 10 is a schematic diagram of an additive manufacturing apparatus 1000. As illustrated in FIG. 10, the additive manufacturing apparatus 1000 includes a processing tank 1011, a stage 1012, a moving device 1013, a nozzle device 1014, an optical device 1015, a measuring device 1016, a control unit 1017 and the like.

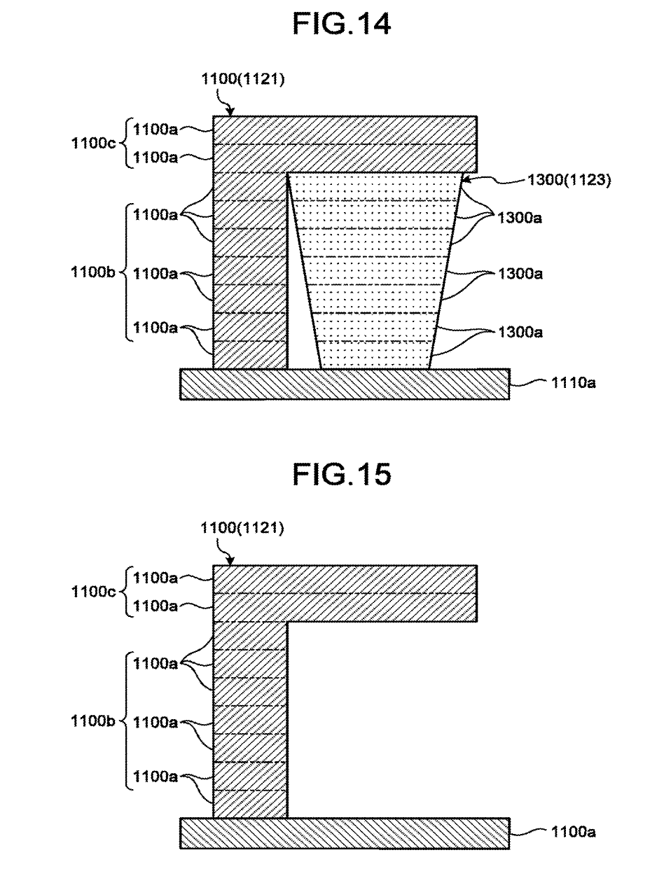

The additive manufacturing apparatus 1000 manufactures an additive manufactured object 1100 of a certain shape, by laminating a material 1120 supplied by the nozzle device 1014 on an object 1110 placed on a stage 1012 in a layer shape. Further, the additive manufacturing apparatus 1000 can manufacture a support member 1300 (a support section, see FIG. 14) which supports the additive manufactured object 1100, when manufacturing the additive manufactured object 1100.

As the material 1120 used in the present embodiment, there are materials 1121 to 1123. The material 1121 and the material 1122 are different kinds of materials from each other. The material 1121 is a material that can be melted or sintered by irradiation with the laser beam L. The material 1121, for example, is a powdered metal material, a resin material, or the like. Meanwhile, the material 1122 is a material through which the laser beam L is transmitted. The material 1122, for example, is a powdered glass material or the like. The material 1122 has absorptivity of the laser beam L lower than that of the material 1121. Further, the material 1123 is a material in which the material 1121 and the material 1122 are mixed with each other. In the present embodiment, the material 1121 is an example of the first material, the material 1122 is an example of the second material, and the material 1123 is an example of the mixed material.

The object 1110 is a target to which the material 1120 is supplied by the nozzle device 1014, and includes a base 1110a and a layer 1110b. The plurality of layers 1110b is laminated on the upper face of the base 1110a. In the present embodiment, as the layer 1110b, there are a layer 1100a of the additive manufactured object 1100 (see FIG. 14), and a layer 1300a of the support member 1300 (see FIG. 14). The layer 1100a is made up of the material 1121, and the layer 1300a is made up of the material 1123. That is, the additive manufactured object 1100 is made up of the material 1121, and the support member 1300 is made up of the material 1123. The base 1110a, for example, may also be referred to as a manufacturing space.

The processing tank 1011 is provided with a main chamber 1021 and an auxiliary chamber 1022. The auxiliary chamber 1022 is provided to be adjacent to the main chamber 1021. A lid section 1023 is provided between the main chamber 1021 and the auxiliary chamber 1022. When the lid section 1023 is opened, the main chamber 1021 and the auxiliary chamber 1022 communicate with each other, and when the lid section 1023 is closed, the main chamber 1021 enters an air-tight state.

An air supply port 1021a and an air exhaust port 1021b are provided in the main chamber 1021. By the operation of an air supply device (not illustrated), an inert gas such as nitrogen or argon is supplied into the main chamber 1021 via the air supply port 1021a. By the operation of an air exhaust device (not illustrated), the gas in the main chamber 1021 is exhausted from the main chamber 1021 via the air exhaust port 1021b.

Further, a transport device (not illustrated) is provided in the main chamber 1021. In addition, a conveying device 1024 is provided from the main chamber 1021 to the auxiliary chamber 1022. The transport device delivers the additive manufactured object 1100 processed in the main chamber 1021 to the conveying device 1024. The conveying device 1024 conveys the additive manufactured object 1100 delivered from the transport device into the auxiliary chamber 1022. That is, the additive manufactured object 1100 processed in the main chamber 1021 is housed in the auxiliary chamber 1022. After the additive manufactured object 1100 is housed in the auxiliary chamber 1022, the lid section 1023 is closed, and the auxiliary chamber 1022 and the main chamber 1021 are isolated from each other.

The stage 1012, the moving device 1013, a part of the nozzle device 1014, the measuring device 1016 and the like are provided in the main chamber 1021.

The stage 1012 supports the object 1110. The moving device 1013 can move the stage 1012 in three axial directions orthogonal to one another.

The nozzle device 1014 supplies the material 1120 to the object 1110 located on the stage 1012. Further, a nozzle 1033 of the nozzle device 1014 irradiates the object 1110 located on the stage 1012 with the laser beam L. The nozzle device 1014 can supply the plurality of materials 1120 in parallel, and can selectively supply one of a plurality of materials 1120. Further, the nozzle 1033 emits the laser beam L in parallel with the supply of material 1120. In the present embodiment, the laser beam L is utilized as the energy rays. As the energy rays, as long as it is possible to melt or sinter the material 1121, rays such as the laser beam L may be used, and an electron beam or the electromagnetic wave of an ultraviolet region from the microwave may be used.

The nozzle device 1014 has supply devices 1031 and 1032, the nozzle 1033, a supply pipe 1034 and the like. The material 1120 (materials 1121 and 1122) is supplied to the nozzle 1033 from the supply device 1031 via a supply pipe 1034.

The supply device 1031 includes a tank 1031a, and a supply unit 1031b. The material 1121 is contained in the tank 1031a. The supply unit 1031b supplies the material 1121 of the tank 1031a in a certain amount. The supply device 1031 supplies the carrier gas (gas) contained in the material 1121. The carrier gas, for example, is an inert gas such as nitrogen or argon.

The supply device 1032 includes a tank 1032a and a supply unit 1032b. The material 1122 is contained in the tank 1032a. The supply unit 1032b supplies the material 1122 of the tank 1032a in a certain amount. The supply device 1032 supplies the carrier gas (gas) contained in the material 1122. The carrier gas, for example, is an inert gas such as nitrogen or argon.

The optical device 1015 includes a light source 1041 and a cable 1210. The light source 1041 includes an oscillation element (not illustrated), and emits the laser beam L by the oscillation of the oscillation element. The light source 1041 may change the power density of the laser beam L to be emitted.

The light source 1041 is connected to the nozzle 1033 via the cable 1210. The laser beam L emitted from the light source 1041 is guided to the nozzle 1033.

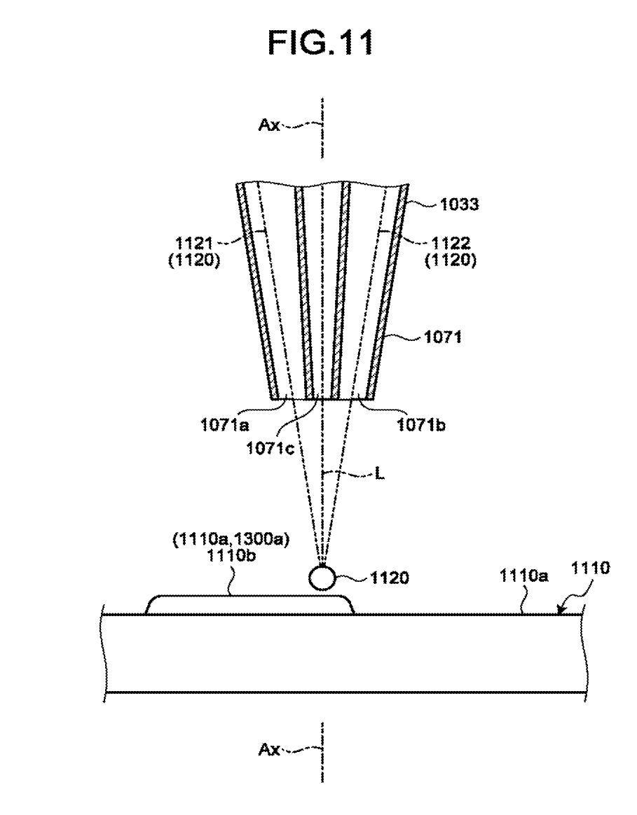

The nozzle 1033 includes a casing 1071. The casing 1071 is configured in a vertically elongated tubular shape. FIG. 11 is a schematic diagram illustrating a part of the nozzle 1033. As illustrated in FIG. 11, passages 1071a, 1071b and 1071c are provided in the interior of the casing 1071.

The passage 1071c overlaps with a central axis Ax of the casing 1071. That is, the passage 1071c extends in a superior-inferior direction. The laser beam L is introduced into the interior of the passage 1071c. An optical system is provided inside the passage 1071c, and the optical system includes a conversion lens which converts the laser beam L into parallel light, and a convergence lens which makes the laser beam L converted into the parallel light converge. The laser beam L is converged to the lower part of the casing 1071 by the convergence lens. The convergence point of laser beam located on the central axis Ax.

The passage 1071a is connected to the supply device 1031 via the supply pipe 1034. The carrier gas and the material 1121 are supplied to the passage 1071a from the supply device 1031. At least a lower part of the passage 1071a is inclined with respect to the central axis Ax to approach the central axis Ax of the casing 1071 toward the lower part. Meanwhile, the passage 1071b is connected to the supply device 1032 via the supply pipe 1034. The carrier gas and the material 1122 are supplied to the passage 1071b from the supply device 1032. At least a lower part of the passage 1071b is inclined with respect to the central axis Ax to approach the central axis Ax of the casing 1071 toward the lower part. Further, at least the lower part of the passages 1071a and at least the lower part of the passage 1071b are inclined to approach each other toward the lower part.

The nozzle 1033 injects the material 1121 toward the lower part of the casing 1071 (passage 1071a) from the lower end portion (opening) of the passage 1071a. The injected material 1121 reaches the convergence point of the laser beam L. Further, the nozzle 1033 injects the material 1122 toward the lower part of the casing 1071 (passage 1071a) from the lower end portion (opening) of the passage 1071b. The injected material 1122 reaches the convergence point of the laser beam L. When the nozzle 1033 injects only the material 1121, only the material 1121 is supplied. Meanwhile, when the nozzle 1033 simultaneously injects the material 1121 and the material 1122, the material 1121 and the material 1122 are mixed with each other in the space which includes the convergence point of the laser beam L of the lower part of the casing 1071. The material 1123 is made up of the mixed materials 1121 and 1122. That is, the nozzle 1033 can supply the material 1123, by injecting the material 1121 and the material 1122 in parallel. Further, a configuration in which the nozzle 1033 injects the material 1123 obtained by mixing the material 1121 and the material 1122 in advance may be adopted.

The material 1121 supplied by the nozzle 1033 is melted by the laser beam L. Meanwhile, since the laser beam L is transmitted through the material 1122 supplied by the nozzle 1033, the material 1122 is not melted and sintered. When only the material 1121 is supplied by the nozzle 1033, a set of molten material 1121 is formed. Meanwhile, when both of the material 1121 and the material 1122 are supplied by the nozzle 1033, the set (material 1123) of the molten material 1121 and the powdered material 1122 is formed. The material 1121 may also be sintered by the laser beam L.

The measuring device 1016 illustrated in FIG. 10 measures the shape of the solidified layer 1110b, the shape of the manufactured additive manufactured object 1100 and the shape of the manufactured support member 1300. The measuring device 1016 transmits information of the measured shape to the control unit 1017. The measuring device 1016, for example, includes a camera 1061 and an image processing device 1062. The image processing device 1062 performs the image processing based on the information measured by the camera 1061. Further, the measuring device 1016, for example, measures the shapes of the layer 1110b, the additive manufactured object 1100 and the support member 1300, by an interference method, a light cutting method or the like.

The control unit 1017 is electrically connected to a moving device 1013, a conveying device 1024, supply devices 1031 and 1032, a light source 1041, and an image processing device 1062 via a signal line 1220.

The control unit 1017 moves the stage 1012 in the three axial directions, by controlling the moving device 1013. The control unit 1017 conveys the manufactured additive manufactured object 1100 into the auxiliary chamber 1022, by controlling the conveying device 1024. The control unit 1017 adjusts the presence or absence of the supply of the material 1120 and the supply amount, by controlling the supply devices 1031 and 1032. The control unit 1017 adjusts the power density of the laser beam L emitted from the light source 1041, by controlling the light source 1041. Further, the control unit 1017 controls the movement of the nozzle 1033.

The control unit 1017 is equipped with a storage unit 1017a. The storage unit 1017a stores the data indicating the ratio of the material 1120 (materials 1121 and 1122), and the manufacturing data indicating the shape (reference shape) of the manufactured additive manufactured object 1100 and the shape (reference shape) of the support member 1300. The manufacturing data, for example, is input from an external personal computer.

The control unit 1017 has a function of determining the shape of the material 1120. For example, the control unit 1017 determines whether a site having no certain shape is formed, by comparing the shapes of the layer 1110b, the additive manufactured object 1100 and the support member 1300 obtained by the measuring device 1016, with the reference shape stored in the storage unit 1017a.

Further, the control unit 1017 has a function of trimming the material 1120 into a certain shape, by removing an unnecessary site which is determined as a site having no certain shape, by determination of the shape of the material 1120. For example, when the material 1120 scatters and adheres to a site different from a certain shape, the control unit 1017 first controls the light source 1041 such that the laser beam L has a power density capable of evaporating the material 1120 (specifically, the material 1121). Next, the control unit 1017 irradiates the site with the laser beam L to evaporate the material 1121.

Next, an example of a procedure (a method for manufacturing the additive manufactured object 1100) for manufacturing the additive manufactured object 1100 by the additive manufacturing apparatus 1000 will be described. The method for manufacturing the additive manufactured object 1100 by the additive manufacturing apparatus 1000 is not limited to a method to be described below.

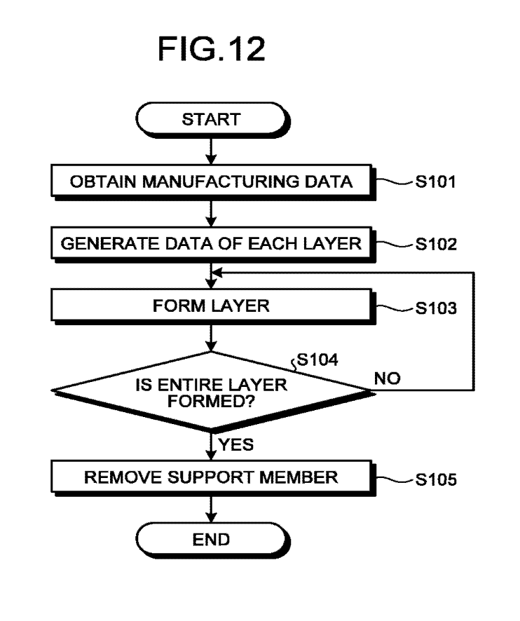

FIG. 12 is a flowchart illustrating an example of a procedure for manufacturing the additive manufactured object 1100. First, the manufacturing data is input to the control unit 1017 of the additive manufacturing apparatus 1000, for example, from an external personal computer, and the control unit 1017 obtains the manufacturing data (S101). The obtained data is stored in the storage unit 1017a.

Next, the control unit 1017 generates the data of each layer 1110b (the layer 1100a and the layer 1300a) from the obtained manufacturing data (S102). The generated data is stored in the storage unit 1017a.

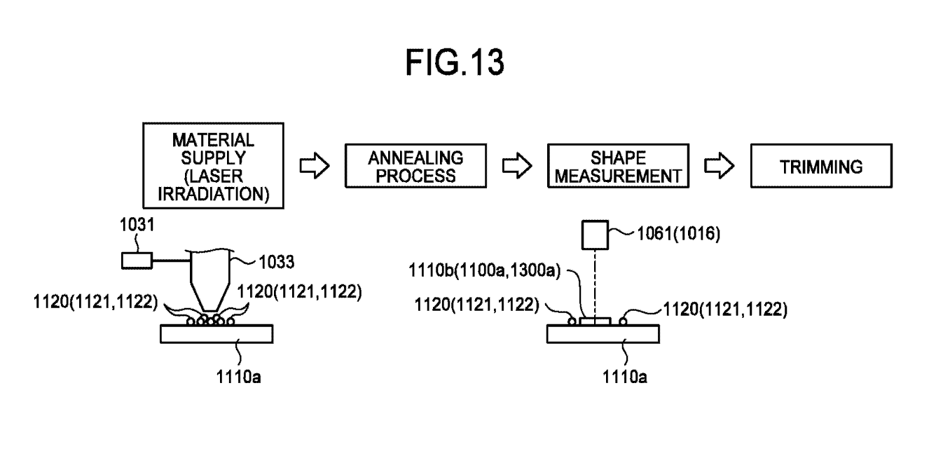

Next, the control unit 1017 controls the nozzle device 1014, the optical device 1015, the measuring device 1016 and the like to form each layer 1110b. The procedure for formation of the layer 1110b will be described with reference to FIG. 13. FIG. 13 is an explanatory view illustrating some of a manufacturing process of the additive manufactured object 1100. First, a case where the layer 1110b is the layer 1100a of the additive manufactured object 1100 will be described. The control unit 1017 performs the supply of the material 1121 and the irradiation with the laser beam L, based on the data of the generated layers 1100a. Specifically, the control unit 1017 controls the supply device 1031 or the like so that the material 1121 is supplied from the nozzle 1033 in a certain range, and controls the light source 1041 so that the supplied material 1121 is melted by the laser beam L. Thus, the molten material 1121 is supplied in a certain amount in the range of forming the layer 1100a on the base 1110a. When injected into the base 1110a and the layer 1100a the material 1121 becomes a set of the layered or thin film-like material 1121. Alternatively, the material 1121 is laminated in a granular shape to form a granular set, by being cooled by the carrier gas conveying the material 1121 or by being cooled by heat transfer to the set of the material 1121. The material 1121 is solidified, by being cooled by the carrier gas conveying the material 1121 or by being cooled by heat transfer to the set of the material 1121.

Next, an annealing process is performed. The annealing process may be performed outside the additive manufacturing apparatus 1000 by the use of an annealing device (not illustrated) or may be performed inside the additive manufacturing apparatus 1000. In the latter case, the control unit 1017 controls the light source 1041 so that the set of material 1121 on the base 1110a is irradiated with the laser beam L. As a result, after the material 1121 in the set of material 1121 is re-melted, the material 1121 is solidified to form the layer 1100a.

Next, the shape measurement is performed. The control unit 1017 controls the measuring device 1016 so as to measure the material 1121 on the base 1110a subjected to the annealing process. The control unit 1017 compares the shapes of the layer 1100a and the additive manufactured object 1100 obtained by the measuring device 1016 with the reference shape stored in the storage unit 1017a.

Next, trimming is performed. The trimming may be performed outside the additive manufacturing apparatus 1000 by the use of a trimming device (not illustrated) or may be performed inside the additive manufacturing apparatus 1000. In the latter case, the control unit 1017 controls the light source 1041 so that the unnecessary material 1121 is evaporated, for example, when it is found that the material 1121 on the base 1110a adheres to a position different from a certain shape, by comparison of the shape measurement with the reference shape. Meanwhile, the control unit 1017 does not perform the trimming, when it is found that the layer 1100a has a certain shape by comparison of the shape measurement with the reference shape.

Even when the layer 1110b is a layer 1300a of the support member 1300, the layer 1300a is formed by the same procedure as the aforementioned procedure. However, in this case, the material 1121 and the material 1122 are supplied in parallel. Further, the material 1122 is not melted and evaporated.

When the formation of the layer 1110b (layers 1100a and 1300a) are finished, the control unit 1017 forms a new layer 1110b on the top of the layer 1110b. As illustrated in FIG. 12, the control unit 1017 sequentially forms the layers 1110b, until the additive manufactured object 1100 is completed (S104: NO). That is, the control unit 1017 manufactures the additive manufactured object 1100 and the support member 1300, by repeatedly laminating the layers 1110b.

Here, an example of the order of the formation of the layer 1100a of the additive manufactured object 1100 and the layer 1300a of the support member 1300 will be described. FIG. 14 is a schematic diagram illustrating a additive manufactured object 1100 and the support member 1300. As illustrated in FIG. 14, an example in which the additive manufactured object 1100 includes a first section 1100b and a second section 1100c will be described. The first section 1100b extends upward from the base 1110a. The cross-sections intersecting with the superior-inferior direction of the first section 1100b are substantially the same at each position in the superior-inferior direction. The first section 1100b is made up of a plurality of layers 1100a. The second section 1100c extends (overhangs) from the first section 1100b in a direction intersecting with (orthogonal to) the superior-inferior direction. The second section 1100c is made up of a plurality of layers 1100a. Each layer 1100a of the additive manufactured object 1100 is made up of the material 1121. Meanwhile, the support member 1300 is located between the base 1110a and the second section 1100c. The upper end portion of the support member 1300 is adjacent (connected) to the second section 1100c. That is, the support member 1300 supports the second section 1100c. The support member 1300 is configured so that the cross-section orthogonal to the superior-inferior direction increases toward the upper part as an example. The support member 1300 is made up of a plurality of layers 1300a. The height of the support member 1300 is the same as the height of the first section 1100b. Each layer 1300a of the support member 1300 is made up of the material 1123.

In the manufacturing of the additive manufactured object 1100 and the support member 1300 having the aforementioned shape, first, each layer 1100a of the first section 1100b of the additive manufactured object 1100 is formed. Next, each layer 1300a of the support member 1300 is formed. Next each layer 1100a of the second section 1100c of the additive manufactured object 1100 is formed. At the time of the formation of the second section 1100c, the second section 1100c and the support member 1300 are connected to each other. Further, each layer 1100a of the first section 1100b of the additive manufactured object 1100, and each layer 1300a of the support member 1300 may be alternately formed, and thereafter, each layer 1100a of the second section 1100c may be formed.

As illustrated in FIG. 12, when the manufacturing of the additive manufactured object 1100 is completed (S104: Yes), the control unit 1017 removes the support member 1300 (material 1123) by a removal device (S105). The removal device removes the support member 1300, for example, by various processes such as cutting or laser machining. FIG. 15 illustrates the additive manufactured object 1100 of a state in which the support member 1300 is removed.

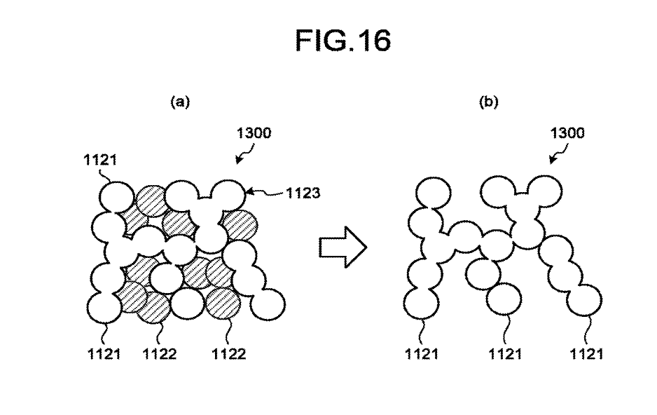

The method of removing the support member 1300 will be described with reference to FIG. 16. FIG. 16 is a schematic diagram illustrating a part of the support member 1300. The support member 1300 is made up of the material 1123 ((a) of FIG. 16). The material 1122 in the material 1123 remains in a powdery state without being solidified. Therefore, at the time of removal of the support member 1300, it is possible to at least partially remove the material 1122 contained in the support member 1300, for example, by suction or injection of the gas ((b) of FIG. 16). Since the support member 1300 can have a porous shape (a porous material) by removing the material 1122 in this way, it is easy to remove the support member 1300. Further the support member 1300 may be removed, without removing the material 1122 from the support member 1300. Even in this case, since the material 1122 remains in a powdery state, the removal of the support member 1300 is easier than a case where the entire area of the support member is solidified after melting. The removal of the support member 1300 may also be performed outside the additive manufacturing apparatus 1000. In the present embodiment, a part of the support member 1300 is a portion which is not desired to be solidified for ease of removal of the support member 1300.

In the present embodiment, the powdered material 1121 (first material) capable of being melted or sintered by irradiation with the laser beam L (energy rays) is supplied, the powdered material 1122 (second material) through which the laser beam L is transmitted is supplied, the material 1121 is melted or sintered by irradiation with the laser beam L, and the material 1121 is solidified after melting or is solidified by sintering. Since the laser beam L is transmitted through the material 1122, even when irradiated with the laser beam L, the material 1122 is not melted and solidified. Therefore, by the use of the material 1122 in a portion (a part of the support member 1300) that is not desired to be solidified among the supplied materials (materials 1121 and 1122), it is possible to suppress the solidification of the portion that is not desired to be solidified.

Further, in the present embodiment, by the irradiation of the material 1123 (mixed material) in which the material 1121 and the material 1122 are mixed with each other with the laser beam L, the material 1121 is melted or sintered. Accordingly, it is possible to melt or sinter only the material 1121 in the material 1123. At this time, the laser beam L is transmitted through the material 1123. Therefore, since the material 1121 located below the material 1123 is irradiated with the laser beam L that is transmitted through the material 1123, the material 1121 can be melted by the laser beam L.

Further, in the present embodiment, a manufactured object is formed which includes the additive manufactured object 1100 as an example of the portion made up of the material 1121, and the support member 1300 as an example of the portion made up of the mixed material 1123. Accordingly, it is possible to obtain the additive manufactured object 1100 made up of the material 1121, and the support member 1300 made up of the material 1123.

Further, in the present embodiment, the additive manufactured object 1100 made up of the material 1121, and the support member 1300 made up of the mixed materials 1123 are adjacent to each other. Therefore, it is possible to support the additive manufactured object 1100 by the support member 1300.

Further, in the present embodiment, after the material 1121 is solidified, the support member 1300 made up of the material 1123 is removed. At this time, a part (material 1122) of the support member 1300 is not solidified. Therefore, it is possible to relatively easily remove the support member 1300.

In the present embodiment, although the description has been given of a case where the portion (manufactured object) made up of the material 1123 is applied to the support member 1300 which supports the additive manufactured object 1100, the present invention is not limited thereto. For example, the additive manufactured object 1100 may have a portion made up of the material 1123, and the entire additive manufactured object 1100 may be made up of the material 1123. In this case, by removing at least some of the material 1122 from the material 1123, for example, by suction and injection of the gas, a part or whole of the additive manufactured object 1100 can have a porous shape.

Further, in the present embodiment, the description has been given of a case where there is a single first material (material 1121), but the present invention is not limited thereto. The first material may be two or more. In this case, a configuration (a supply device, a supply pipe, and a passage of nozzle) for supplying the first material may be provided for each first material. Further, in this case, two or more first materials may be individually supplied (injected), two or more first materials may be supplied (injected) in parallel and the two or more first materials may be mixed with each other.

As described above, according to each of the embodiments, by the use of the materials 4 and 1122 in a portion (the region R3, a part of the support member 1300) which is not desired to be solidified among the supplied materials (materials 2 to 4, and 1121 to 1123), it is possible to suppress the solidification of the portion that is not desired to be the solidified.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. (canceled)

2. A method for manufacturing an additive manufactured object, the method comprising:
supplying a powdered first material capable of being melted or sintered by irradiation with energy rays;
supplying a powdered second material having absorptivity of the energy rays lower than the first material; and
melting or sintering the first material by irradiation with the energy rays, wherein
the first material and the second material are adjacent to each other.

3. The method according to claim 2, wherein
the supplying of the first material includes supplying the first material, and
the supplying of the second material includes supplying the second material to a second region adjacent to the first region.

4. The method according to claim 3, wherein
the first material includes a plurality of different first materials,
the supplying of the first material includes the plurality of different first materials to the first region.

5. The method according to claim 3, wherein the first region, and a third region being a part of the second region and being adjacent to the first region are irradiated with the energy rays, in the melting or sintering of the first material.

6. The method according to claim 2, wherein the second material is removed, after solidifying the first material after melting the first material, or after sintering the first material.

7. (canceled)

8. A method for manufacturing an additive manufactured object, the method comprising:
supplying a powdered first material capable of being melted or sintered by irradiation with energy rays;
supplying a powdered second material having absorptivity of the energy rays lower than the first material; and
melting or sintering the first material by irradiation with the energy rays, wherein
the melting or sintering of the first material includes melting or sintering the first material by irradiation of a material in which the first material and the second material are mixed with each other with the energy rays,
the method further comprising:
forming a portion made up of the first material, and a portion made up of the mixed material.

9. The method according to claim 8, wherein the portion made up of the first material and a portion made up of the mixed material are adjacent to each other.

10. The method according to claim 9, further comprising:
removing the portion made up of the mixed material, after solidifying the first material after melting the first material, or after sintering the first material.

11-12. (canceled)
